(19) United States
(12) Patent Application Publication
(10) Pub. No.: US 2006/0087214 A1
(43) Pub. Date: Apr. 27, 2006

(54) Cathode ray tube

(75) Inventor: Sung Han Jung, Kyungsangbuk-do (KR)

Correspondence Address: BIRCH STEWART KOLASCH & BIRCH, PO BOX 747, FALLS CHURCH, VA, 22040-0747, US

(73) Assignee: LG. Philips Displays Korea CO., LTD., Kyungsangbuk-do (KR)

(21) Appl. No.: 11/253,548

(22) Filed: Oct. 20, 2005

(30) Foreign Application Priority Data
Oct. 21, 2004 (KR) 2004-84506

(51) Int. Cl. H01J 29/10

(52) U.S. Cl. 313/461

(57) ABSTRACT

A cathode ray tube comprising a panel having a complex curvature at an outer surface of the panel such that the complex outer surface curvature satisfies a condition

$$“ 0.5 \leq \frac{Rx + Ry}{2 \times Rd} \leq 0.9 ” ,$$

where “Rx” represents a radius of the outer surface curvature of the panel along a longer axis of the panel, “Ry” represents a radius of the outer surface curvature of the panel along a shorter axis of the panel, and “Rd” represents a radius of the outer surface curvature of the panel along a diagonal axis of the panel. In accordance with this complex curvature, it is possible to reduce the weight of the panel while eliminating generation of an image distortion phenomenon and providing desired apparent flatness. It is also possible to easily design the curvature of the inner surface of the panel and the curvature of a shadow mask used in the cathode ray tube, and thus, to achieve an improvement in doming characteristics and an improvement in drop characteristics.

### BACKGROUND OF THE INVENTION

1. Field of the Invention

The present invention relates to a cathode ray tube, and, more particularly, to a cathode ray tube which includes a panel having an optimal curvature at an outer surface thereof to eliminate an image distortion phenomenon, to provide apparent flatness, to lighten the panel, and to improve doming characteristics and drop characteristics of the cathode ray tube.

2. Description of the Related Art

A conventional cathode ray tube will be described hereinafter with reference to FIG. 1.

FIG. 1 is a sectional view illustrating an inner configuration of a conventional cathode ray tube. As shown in FIG. 1, the conventional cathode ray tube includes a panel 1 having an inner surface, on which a phosphor material is coated, a funnel 2 coupled to the panel 2 to form a hollow vacuum body, an electron gun (not shown) arranged in the hollow vacuum body to emit an electron beam 4, and a deflection yoke 6 adapted to vertically and horizontally deflect the electron beam 4. The cathode ray tube also includes a shadow mask 3 provided with a plurality of slots to perform a color selecting function for the electron beam 4 deflected by the deflection yoke 6, and a frame 5 connected to the shadow mask 3 to support the shadow mask 3.

In the conventional cathode ray tube having the above-mentioned configuration, the electron beam 4 strikes a phosphor coated on the inner surface of the panel 1, thereby causing the phosphor to emit light by virtue of the energy of the electron beam 4. Thus, an image is reproduced.

Recently, cathode ray tubes have been advanced to have an increased size and an increased flatness, in order to secure competitiveness. Where the above-mentioned cathode ray tube has such a structure, the panel 1 must be substantially flat at an outer surface thereof, and must have the same radius of curvature on the outer surface along a longer axis, a shorter axis and a diagonal axis respectively passing through the center of the outer surface.

The shadow mask 3 also has a curvature similar to the curvature of an inner surface of the panel 1.

Where the inner surface of the panel 1 is flattened, accordingly, the shadow mask 3 must be flattened to conform to the flatness of the inner surface of the panel 1, for the image color selecting function. In this case, however, the rigidity of the shadow mask 3 is reduced. As a result, the shadow mask 3 may exhibit deformation caused by external impact applied to the shadow mask 3, for example, a drop phenomenon, thermal deformation such as a doming phenomenon, or a vibrating phenomenon such as a howling phenomenon.

In order to solve such problems, the panel 1 must have an arch-shaped inner surface, and the shadow mask 3 must have an arch-shaped curvature. In this case, however, the panel 1 exhibits a curvature difference between the inner and outer surfaces thereof, so that the panel 1 has a thickened peripheral portion.

Where the panel 1 exhibits a larger thickness difference between the central and peripheral portions thereof, as mentioned above, the panel 1 may be thermally deformed due to a heat conductivity difference between the upper and lower ends thereof, so that the panel 1 may be damaged.

Furthermore, where the panel 1 has a thickened peripheral portion, a degradation in brightness may occur. Although such a brightness degradation may be eliminated by increasing the width of the phosphor layer on the peripheral portion of the panel 1, there may be a degradation in image color purity in this case.

In addition, where the shadow mask 3 is made of an invar material in the case in which the panel 1 has a flat inner surface, and the shadow mask 3 is correspondingly flat, the material costs of the shadow mask 3 increase, thereby causing an increase in the manufacturing costs of the cathode ray tube.

### SUMMARY OF THE INVENTION

The present invention has been made in view of the problems incurred in the above-mentioned conventional case, and it is an object of the invention to provide a cathode ray tube which includes a panel having an optimal curvature at an outer surface thereof to reduce the weight of the panel while obtaining desired apparent flatness, thereby being capable of achieving a reduction in manufacturing costs.

In accordance with one aspect, the present invention provides a cathode ray tube comprising a panel having a predetermined curvature at an inner surface of the panel, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein the panel has a predetermined curvature at an outer surface of the panel such that the predetermined outer surface curvature satisfies the following condition:

$$0.5 \leq \frac{Rx + Ry}{2 \times Rd} \leq 0.9$$

where, “Rx” represents a radius of the outer surface curvature of the panel along a longer axis of the panel, “Ry” represents a radius of the outer surface curvature of the panel along a shorter axis of the panel, and “Rd” represents a radius of the outer surface curvature of the panel along a diagonal axis of the panel.

In accordance with another aspect, the present invention provides a cathode ray tube comprising a panel having a predetermined curvature at an inner surface of the panel, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein the panel has a predetermined curvature at an outer surface of the panel such that the predetermined outer surface curvature satisfies a condition “5,000 mm≦Rx, Ry, Rd≦30,000 mm” and a condition that at least one of Rx, Ry, and Rd is different from the remaining ones of Rx, Ry, and Rd, where “Rx” represents a radius of the outer surface curvature of the panel along a longer axis of the panel, “Ry” represents a radius of the outer surface curvature of the panel along a shorter axis of the panel, and “Rd” represents a radius of the outer surface curvature of the panel along a diagonal axis of the panel.

In accordance with another aspect, the present invention provides a cathode ray tube comprising a panel having a predetermined curvature at an inner surface of the panel, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein the panel has a predetermined curvature at an outer surface of the panel such that the predetermined outer surface curvature satisfies the following condition:
Rx≦Ry<Rd or
Ry≦Rx<Rd

where, “Rx” represents a radius of the outer surface curvature of the panel along a longer axis of the panel, “Ry” represents a radius of the outer surface curvature of the panel along a shorter axis of the panel, and “Rd” represents a radius of the outer surface curvature of the panel along a diagonal axis of the panel.

The panel may satisfy the following condition:

$$0.18 \leq \frac{OAH}{\frac{1}{2} USD} \leq 0.29$$

where, “USD” represents a diagonal length of an effective screen surface of the panel, and “OAH” represents a vertical length from a center of the outer surface of the panel to a seal surface of the panel.

### BRIEF DESCRIPTION OF THE DRAWINGS

The above objects, and other features and advantages of the present invention will become more apparent after reading the following detailed description when taken in conjunction with the drawings, in which:

FIG. 1 is a sectional view illustrating an inner configuration of a conventional cathode ray tube;

FIG. 2 is a schematic view illustrating the outer surface curvature of a panel in a cathode ray tube according to the present invention;

FIG. 3 is a sectional view illustrating a structure of the panel in the cathode ray tube according to the present invention, as compared to that of a conventional case;

FIG. 4 is a schematic view showing the diagonal length of an effective surface of the panel and the length of a skirt of the panel in the cathode ray tube according to the present invention;

FIG. 5 is a schematic view illustrating the curvature of the inner surface of the panel in the cathode ray tube according to the present invention;

FIG. 6 is a schematic view showing a deflection angle in the cathode ray tube according to the present invention;

FIGS. 7A to 7E are schematic views illustrating the apparent flatness of an image displayed on a panel depending on the outer surface curvature radius of the panel, respectively; and

FIG. 8 is a sectional view illustrating an image suspension phenomenon occurring in the cathode ray tube panel according to the present invention, as compared to that of a conventional case.

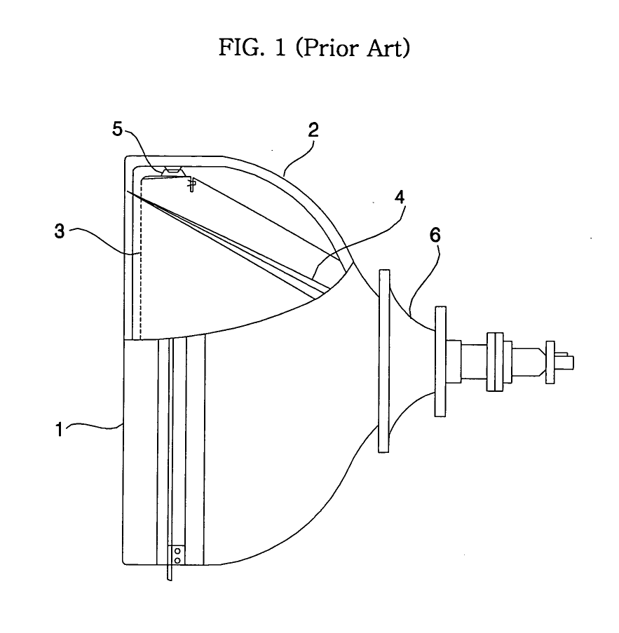

### DESCRIPTION OF THE PREFERRED EMBODIMENTS

Hereinafter, exemplary embodiments of a cathode ray tube according to the present invention will be described with reference to the annexed drawings. In the following description, the same elements are referred to by the same title and designated by the same reference numeral.

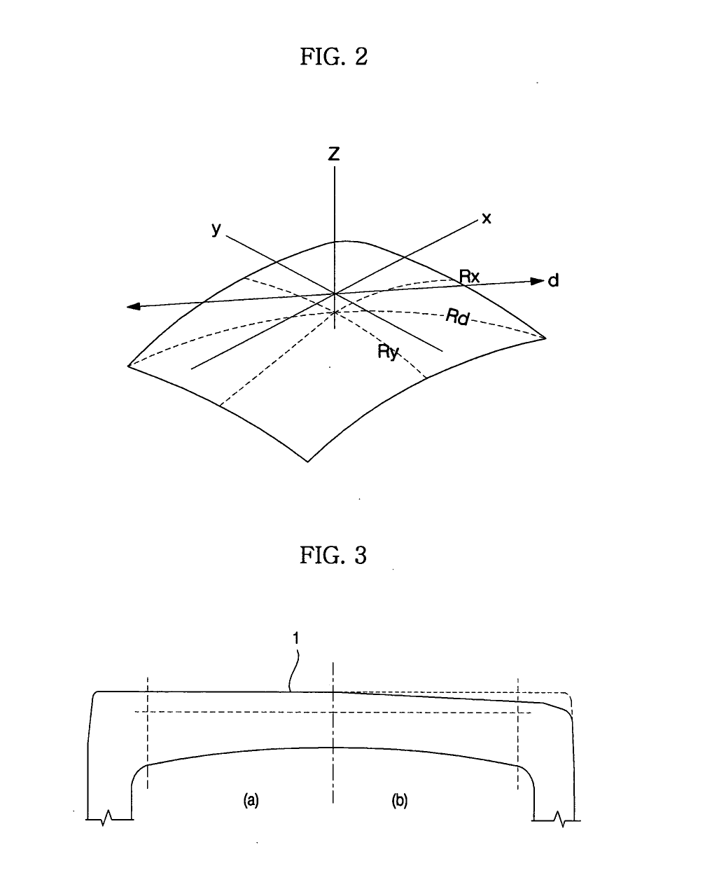

FIG. 2 is a schematic view illustrating the outer surface curvature of a panel in a cathode ray tube according to a first embodiment of the present invention. FIG. 3 is a sectional view illustrating a structure of the panel in the cathode ray tube according to the first embodiment of the present invention.

Referring to FIG. 2, an outer surface of a panel 1 included in a cathode ray tube according to the first embodiment of the present invention is illustrated. In FIG. 2, the longer axis, shorter axis, and diagonal axis of the panel 1 may be defined as an x-axis, a y-axis, and a d-axis, respectively. In FIG. 2, the radius of the outer surface curvature of the panel 1 along the longer axis is represented by “Rx”, the radius of the outer surface curvature of the panel 1 along the shorter axis is represented by “Ry”, and the radius of the outer surface curvature of the panel 1 along the diagonal axis is represented by “Rd”.

In FIG. 2, “z-axis” represents the central axis of the panel.

In the panel 1 of the cathode ray tube according to the first embodiment of the present invention, at least one of the outer surface curvature radii Rx, Ry, and Rd is different from the remaining ones of the outer surface curvature radii Rx, Ry, and Rd such that the panel 1 has a complex curvature. In particular, in accordance with such a curvature radius difference, the outer surface of the panel 1 has a slightly convex shape, so that the panel 1 has a reduced absolute thickness at a peripheral portion thereof.

The outer surface curvature radii Rx, Ry and Rd of the panel 1 along respective axes in the cathode ray tube according to the first embodiment of the present invention satisfy the following Condition 1:

$$0.5 \leq \frac{Rx + Ry}{2 \times Rd} \leq 0.9 \qquad [ Condition 1 ]$$

Where the panel 1 has an outer surface curvature larger than a predetermined curvature, so that the panel 1 is too convex, the outer surface of the panel 1 serves as a mirror, thereby reflecting external light toward the viewer at diverse angles. In this case, accordingly, a degradation in picture quality occurs. Furthermore, where the viewer views the panel 1 for a prolonged period of time, the fatigue of the viewer's eyes increases.

When the value of

$$\frac{Rx + Ry}{2 \times Rd}$$

in Condition 1 is less than 0.5, an image distortion phenomenon occurs due to a curvature difference between the central and peripheral portions of the panel 1. In this case, accordingly, a degradation in apparent flatness occurs, so that there is a problem in reproducing an image.

Meanwhile, it is preferred that the inner surface curvature of the panel 1 have a relation with the outer surface curvature of the panel 1 in order to prevent the thickness difference between the central and peripheral portions of the panel 1 from being excessive. Also, the curvature of a shadow mask included in the cathode ray tube according to the first embodiment of the present invention depends on the inner surface curvature of the panel 1.

When the value of

$$\frac{Rx + Ry}{2 \times Rd}$$

in Condition 1 is more than 0.9, the outer surface of the panel 1 is flattened, so that the inner surface of the panel 1 and the shadow mask have an insufficient curvature. As a result, where the shadow mask is made of an aluminum killed (AK) material, a doming phenomenon may occur, thereby causing a degradation in picture quality. Furthermore, the space between the panel 1 and the shadow mask is too large, thereby causing a landing phenomenon and a degradation in image color purity.

When the shadow mask has an insufficient curvature in the case in which the shadow mask is made of an invar material, the strength of the shadow mask is greatly reduced. In this case, a howling or drop phenomenon may occur. Furthermore, the shadow mask, which is made of the invar material, causes an increase in the manufacturing costs. As a result, it is impossible to effectively achieve the purpose of manufacturing cost reduction through a reduction in the weight of the panel 1.

Therefore, it is preferred that outer surface curvature radii of the panel 1 satisfy the condition of

$$0.5 \leq \frac{Rx + Ry}{2 \times Rd} \leq 0.9 ,$$

as described above.

FIG. 3 illustrates the panel 1 having the above-described outer surface curvature radii for the comparison thereof with the conventional panel. Where the panel 1 has a flat outer surface, as shown in a portion “a” of FIG. 3, the panel 1 has an excessively increased thickness at the peripheral portion thereof, so that the panel 1 exhibits degraded brightness characteristics at the peripheral portion thereof. Where the inner surface of the panel 1 and the shadow mask are flattened to solve this problem, the above-described problems such as the doming, howling and drop phenomena may occur.

When the outer surface curvature radii of the panel 1 satisfy the range defined by Condition 1 in accordance with the first embodiment of the present invention, the panel 1 has a structure shown in a portion “b” of FIG. 3. In this case, the outer surface of the panel 1 is slightly convex while preventing a degradation in the apparent flatness perceived by the viewer when the viewer views the screen of the panel 1.

In this case, it is possible to reduce the thickness of the peripheral portion of the panel 1, and thus, to reduce the weight of the panel 1 and to achieve an improvement in the brightness characteristics exhibited at the peripheral portion of the panel 1. Since the outer surface of the panel 1 has a slightly convex shape, there is an advantage in manufacturing the panel 1 to have a desired curvature at the inner surface of the panel 1, and in manufacturing the shadow mask to have a desired curvature. Accordingly, it is possible to eliminate the above-described problems caused by doming, howling and drop phenomena.

In accordance with a second embodiment of the present invention, a cathode ray tube is provided which includes a panel 1 satisfying the condition of 5,000 mm≦Rx, Ry, Rd≦30,000 mm and the condition that at least one of Rx, Ry, and Rd is different from the remaining ones of Rx, Ry, and Rd, wherein “Rx” represents the radius of the outer surface curvature of the panel 1 along the longer axis of the panel 1, “Ry” represents the radius of the outer surface curvature of the panel 1 along the shorter axis of the panel 1, and “Rd” represents the radius of the outer surface curvature of the panel 1 along the diagonal axis of the panel 1.

When each outer surface curvature radius of the panel 1 is less than 5,000 mm, the panel 1 is excessively convex, thereby causing a degradation in apparent flatness. In this case, severe image distortion occurs, thereby causing a problem in reproducing an image. Furthermore, the outer surface of the panel 1 serves as a mirror, thereby reflecting external light toward the viewer at diverse angles. In this case, accordingly, a degradation in picture quality occurs. Furthermore, the fatigue of the viewer's eyes increases.

In this cathode ray tube, there may be a jointing problem in that a gap is present between the panel 1 and a cabinet surrounding the panel 1. For this reason, it is necessary to use new molds, thereby causing an increase in manufacturing costs.

On the other hand, when each outer surface curvature radius of the panel 1 is more than 30,000 mm, it is impossible to sufficiently reduce the weight of the panel 1, so that an insufficient manufacturing cost reduction is obtained.

Moreover, since the outer surface of the panel 1 is flattened, it is impossible to provide a shadow mask 3 having a sufficient curvature. For this reason, where the shadow mask 3 is made of an invar material, the strength of the shadow mask 3 is reduced, thereby degrading howling and drop characteristics.

Also, where the shadow mask 3 is made of an AK material, the curvature of the shadow mask 3 is insufficient, so that a doming phenomenon may occur, thereby causing a degradation in picture quality. In addition, the space between the panel 1 and the shadow mask 3 is excessively large, thereby causing a landing phenomenon and a degradation in image color purity.

Therefore, it is preferred that the outer surface curvature radii of the panel 1 range from 5,000 mm to 30,000 mm, in order to improve the apparent flatness perceived by the viewer when the viewer views the screen of the panel 1, and to reduce an image distortion occurring in the cathode ray tube.

Meanwhile, in accordance with a third embodiment of the present invention, a cathode ray tube is provided which includes a panel 1 satisfying the condition of Rx≦Ry<Rd or the condition of Ry≦Rx<Rd, wherein “Rx” represents the radius of the outer surface curvature of the panel 1 along the longer axis of the panel 1, “Ry” represents the radius of the outer surface curvature of the panel 1 along the shorter axis of the panel 1, and “Rd” represents the radius of the outer surface curvature of the panel 1 along the diagonal axis of the panel 1.

When the longer and shorter-axis outer surface curvature radii Rx and Ry are larger than the diagonal-axis outer surface curvature radius Rd, the space between the panel 1 and the shadow mask 3 is excessively large, thereby causing a landing phenomenon and a degradation in image color purity. In this case, there is also a problem in that a desired curvature cannot be precisely formed in a process of polishing the outer surface of the panel 1 in the manufacture of the panel 1.

Therefore, it is preferred that the panel 1 satisfy the condition of Rx≦Ry<Rd or the condition of Ry≦Rx<Rd, in order to prevent an image distortion phenomenon, and thus, a degradation in apparent flatness, and to solve problems in jointing the panel 1 to the cabinet and in precisely forming a desired curvature in the process of polishing the outer surface of the panel 1 after the manufacture of the panel 1.

In the cathode ray tube according to the present invention, brightness uniformity characteristics may be influenced by the thickness difference between the central and corner portions of the panel 1. This influence may be remarkable where the panel 1 is made of a tint-based material. Therefore, in accordance with the present invention, the panel 1 is designed such the ratio of the transmissivity of the central panel portion to the transmissivity of each diagonal panel end portion ranges from 40% to 60%, in order to obtain desired effects.

As described above, the shadow mask, which may be applied to the cathode ray tube according to the present invention, may be made of an invar or AK material. In the case of a shadow mask made of the AK material, however, there may be a greatly adverse affect in terms of a doming phenomenon because the shadow mask has a high thermal expansion coefficient.

In accordance with the present invention, however, desirable effects may be obtained even when the shadow mask made of the AK material is used, by forming the panel 1 such that the outer surface of the panel 1 has a predetermined curvature. This is because the shadow mask can advantageously have a desired curvature in accordance with the curvature of the outer surface of the panel 1.

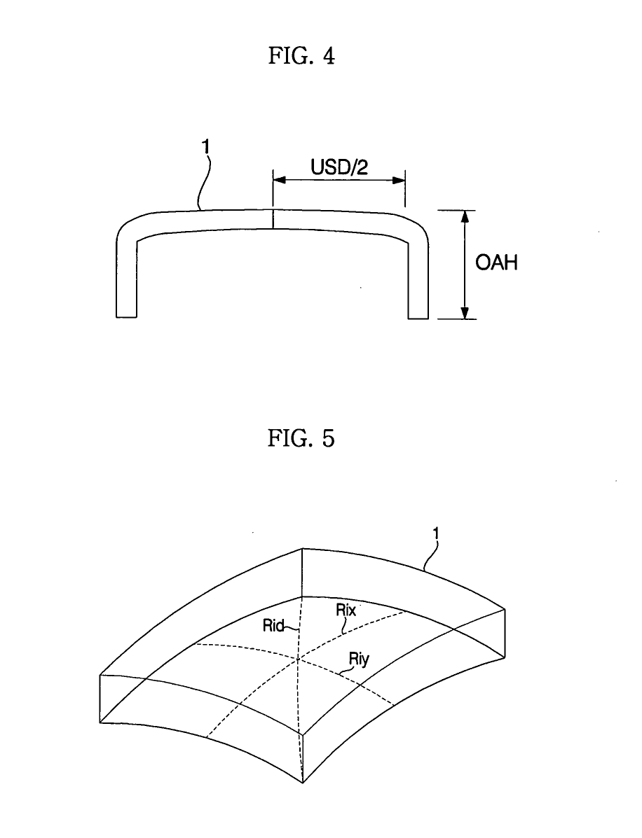

FIG. 4 is a schematic view showing the diagonal length of an effective surface of the panel and the length of a skirt of the panel in the cathode ray tube according to the present invention.

In FIG. 4, “USD” represents the diagonal length of the effective surface of the panel 1, and “OAH” represents the vertical length from the center of the outer surface of the panel 1 to an edge of the skirt of the panel 1, where the panel 1 is joined with a funnel.

It is preferred that the USD and OAH of the cathode ray tube according to the present invention satisfy the following Condition 2:

$$0.18 \leq \frac{OAH}{\frac{1}{2} USD} \leq 0.29 \qquad [ Condition 2 ]$$

When the value of

$$\frac{OAH}{\frac{1}{2} USD}$$

is less than 0.18, wide-angle deflection occurs, thereby causing an increase in power consumption and a degradation in picture quality. On the other hand, when the value of

$$\frac{OAH}{\frac{1}{2} USD}$$

is less than 0.29, the effect of cost reduction through a reduction in the weight of the panel 1 in the cathode ray tube according to the present invention, improved over conventional cathode ray tubes, is insignificant.

Therefore, it is preferred that the value of

$$\frac{OAH}{\frac{1}{2} USD}$$

be within a range from 0.18 to 0.29.

FIG. 5 illustrates the curvature of the inner surface of the panel in the cathode ray tube according to the present invention. In FIG. 5, “Rix” represents the radius of the inner surface curvature of the panel 1 along the longer axis of the panel 1, “Riy” represents the radius of the inner surface curvature of the panel 1 along the shorter axis of the panel 1, and “Rid” represents the radius of the inner surface curvature of the panel 1 along the diagonal axis of the panel 1.

In the cathode ray tube according to the present invention, it is preferred that the inner surface curvature radii Rix, Riy, and Rid satisfy the condition of Rix≦Riy<Rid or the condition of Riy≦Rix<Rid.

It is also preferred that the inner surface curvature of the panel 1 depend on the outer surface curvature of the panel 1. When the inner surface curvature radii Rix, Riy, and Rid satisfy the condition of Rix≦Riy<Rid or the condition of Riy≦Rix<Rid, at least one of the inner surface curvature radii along respective axes of the panel 1 is different from the remaining inner surface curvature radii, similarly to the outer surface curvature radii.

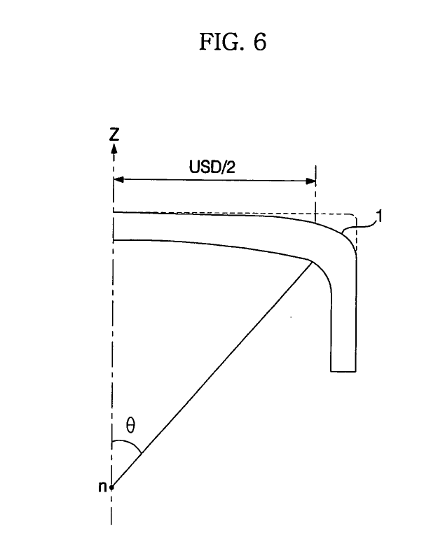

Meanwhile, FIG. 6 is a schematic view showing a deflection angle in the cathode ray tube. In FIG. 6, “θ” represents an angle defined between the central axis z of the panel 1 and the travel path of the electron beam when the electron beam is deflected from a deflection center n such that the electron beam strikes a diagonal end of the effective surface of the panel 1. The maximum deflection angle of the cathode ray tube corresponds to 2θ.

The cathode ray tube according to the present invention is applicable to even wide-angle cathode ray tubes having, a deflection angle of 120°.

The following Table 1 shows a weight reduction of the panel 1 having a single outer surface curvature radius, which varies depending on a variation in the outer surface curvature radius of the panel 1, and a cost reduction according to the weight reduction.

TABLE 1

| Outer Curvature Radius | Weight Reduction | Cost Reduction |
|---|---|---|
| (mm) | (Kg) | ($) |
| 50,000 | 0.21 | 0.19 |
| 30,000 | 0.35 | 0.33 |
| 10,000 | 0.84 | 0.80 |
| 5,000 | 1.68 | 1.60 |

Results of Table 1 are associated with 29-inch panels respectively having different curvature radii within a range from 5,000 mm to 50,000 mm.

Referring to Table 1, it can be seen that, when the outer surface curvature radius of the panel 1 varies from 10,000 mm to 30,000 mm, the weight reduction of the panel 1 is varied from 0.35 Kg to 0.84 Kg, and the reduction in manufacturing costs is varied from $0.33 to $0.80.

On the other hand, the following Table 2 shows the characteristics of the cathode ray tube depending on the outer surface curvature of the panel 1 where the shadow mask of the cathode ray tube is made of an AK material.

TABLE 2

| | AK + | AK + | AK + | AK + |
|---|---|---|---|---|
| Characteristics | 100,000 | 30,000 | 10,000 | 5,000 |
| Local Doming | 110 μm | 84 μm | 70 μm | 60 μm |
| Raster Doming | 105 μm | 67 μm | 57 μm | 45 μm |
| Drop | 21 G | 27 G | 33 G | 40 G |

Referring to Table 2, it can be seen that, where the shadow mask of the cathode ray tube is made of an AK material, the inner surface curvature radius of the panel 1 is reduced, lower than those of conventional cases, when the outer surface curvature radius of the panel 1 is reduced. Accordingly, it is possible to reduce the curvature radius of the shadow mask having close correlation with the curvature radius of the shadow mask, and thus, to improve the doming characteristics and drop characteristics of the cathode ray tube.

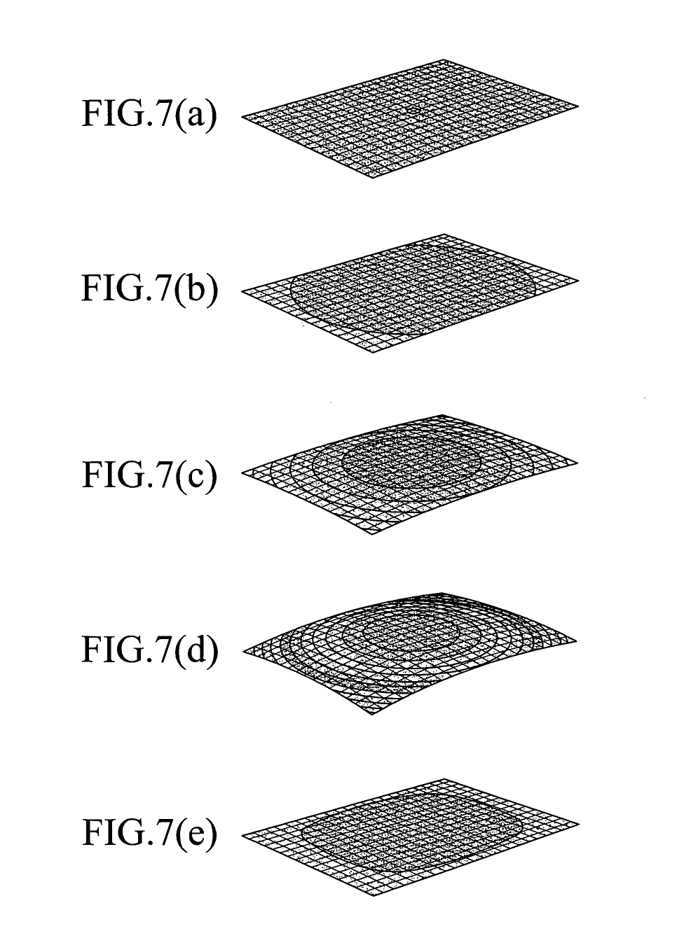

FIGS. 7A to 7E are schematic views illustrating the apparent flatness of an image displayed on a panel depending on the outer surface curvature radius of the panel, respectively.

FIGS. 7A to 7D correspond to 29-inch cathode ray tubes using conventional panels with different outer surface curvature radii, respectively. FIG. 7A shows a panel having an outer surface curvature radius of 50,000 mm, FIG. 7B shows a panel having an outer surface curvature radius of 30,000 mm, FIG. 7C shows a panel having an outer surface curvature radius of 10,000 mm, and FIG. 7D shows a panel having an outer surface curvature radius of 5,000 mm.

Referring to FIGS. 7A to 7D, it can be seen that the conventional panels, each of which has a single curvature radius, exhibit a considerable degradation in apparent flatness in accordance with a reduction in curvature radius.

On the other hand, FIG. 7E corresponds to a 29-inch cathode ray tube using a panel having outer surface curvature radii Rx, Ry and Rd satisfying the condition of

$$0.5 \leq \frac{Rx + Ry}{2 \times Rd} \leq 0.9 ,$$

wherein Rx, Ry, and Rd are 15,000 mm, 22,000 mm, and 27,000 mm, respectively, in accordance with the present invention.

The panel shown in FIG. 7E has an outer surface having a complex curvature with the above-described curvature radii Rx, Ry and Rd. In accordance with such a complex curvature, the panel of FIG. 7E exhibits apparent flatness similar to the panel of FIG. 7B having a single curvature radius of 30,000 mm.

Thus, the panel 1, which has the above-mentioned complex curvature according to the present invention, exhibits desired apparent flatness without generating image distortion, while having outer surface curvature radii smaller than those of conventional cases. In addition, it is possible to provide an increased design margin in designing the inner surface of the panel 1 and the curvature of a shadow mask used in association with the panel 1, as compared to conventional cases.

In the case of a conventional panel having a large outer surface curvature radius, there is a limitation in reducing the inner surface curvature radius. In the case of the panel 1 according to the present invention, which satisfies the above-mentioned condition, however, it is possible to reduce the inner surface curvature radius of the panel 1 and the curvature radius of the shadow mask used in association with the panel 1. For this reason, it is possible to provide an increased design margin in designing the inner surface of the panel 1 and the curvature of the shadow mask, as compared to conventional cases.

Since the curvature radius of the shadow mask can be reduced in accordance with the present invention, it is also possible to greatly improve the drop and howling characteristics of the shadow mask, and to implement a shadow mask design capable of reducing damage of the shadow mask when the shadow mask is processed in a furnace.

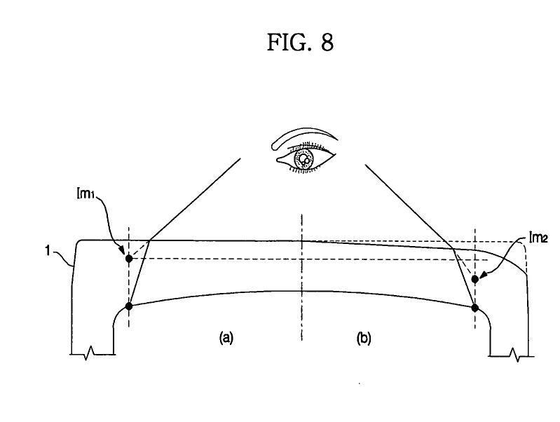

FIG. 8 is a sectional view illustrating an image suspension phenomenon occurring in cathode ray tube panels.

The portion “a” of FIG. 8 corresponds to a conventional cathode ray tube panel, which has a flat outer surface. As shown in the portion “a” of FIG. 8, an image, which is displayed on the inner surface of the panel, is viewed in a state of being suspended at a position Im1 due to a refraction phenomenon of the image occurring in the panel. On the other hand, the portion “b” of FIG. 8 corresponds to the cathode ray tube panel according to the present invention, which has an outer surface having a predetermined curvature. In accordance with the outer surface curvature, the image displayed on the inner surface of the panel according to the present invention is viewed in a state of being suspended at a position Im2.

Referring to FIG. 8, it can be seen that the distance between the outer surface of the panel according to the present invention and the suspended image position Im2 is substantially identical to the distance between the outer surface of the conventional panel and the suspended image position Im1.

Meanwhile, either the cathode ray tube of the present invention or the conventional cathode ray tube encounters a phenomenon that the panel thereof is inwardly sunk at its central portion due to the atmospheric pressure because the interior of the cathode ray tube is in a vacuum state. Due to such a phenomenon, in the case of the panel according to the present invention, more improved apparent flatness is obtained.

In the case of a panel, which has a substantially flat outer surface in accordance with a large outer surface curvature radius, the panel may have a concave shape caused by the sink phenomenon occurring in the panel due to the atmospheric pressure.

Although the preferred embodiments of the invention have been disclosed for illustrative purposes with reference to the annexed drawings illustrating cathode ray tubes, those skilled in the art will appreciate that various modifications, additions and substitutions are possible, without departing from the scope and spirit of the invention as disclosed in the accompanying claims.

As apparent from the above description, in the cathode ray tube according to the present invention, the panel thereof has an outer surface structure having a complex curvature. Also, the outer surface structure of the panel is designed to have optimal curvature radii along respective axes of the panel. Accordingly, there are effects capable of improving the apparent flatness perceived by the viewer when the viewer views the screen of the panel, while achieving a reduction in panel weight, and thus, a reduction in manufacturing costs.

Since the outer surface of the panel has such a curvature, it is possible to easily design the curvature of the inner surface of the panel and the curvature of the shadow mask, and thus, to achieve an improvement in doming characteristics and an improvement in drop characteristics.

What is claimed is:

1. A cathode ray tube comprising a panel having a predetermined curvature at an inner surface of the panel, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein:
the panel has a predetermined curvature at an outer surface of the panel such that the predetermined outer surface curvature satisfies the following condition:
$$0.5 \leq \frac{Rx + Ry}{2 \times Rd} \leq 0.9$$
where, “Rx” represents a radius of the outer surface curvature of the panel along a longer axis of the panel, “Ry” represents a radius of the outer surface curvature of the panel along a shorter axis of the panel, and “Rd” represents a radius of the outer surface curvature of the panel along a diagonal axis of the panel.

2. The cathode ray tube according to claim 1, wherein the outer surface curvature radii of the panel along respective axes of the panel satisfy the following condition:
5,000 mm≦Rx, Ry, Rd≦30,000 mm.

3. The cathode ray tube according to claim 2, wherein the outer surface curvature radii of the panel along respective axes of the panel satisfy a condition “Rx≦Ry<Rd” or “Ry≦Rx<Rd”.

4. The cathode ray tube according to claim 1, wherein the panel has a ratio of transmissivity of a central panel portion to a transmissivity of each diagonal panel end portion ranging from 40% to 60%.

5. The cathode ray tube according to claim 1, wherein the shadow mask is made of an invar material.

6. The cathode ray tube according to claim 1, wherein the shadow mask is made of aluminum killed (AK) material.

7. The cathode ray tube according to claim 1, wherein the panel satisfies the following condition:
$$0.18 \leq \frac{OAH}{\frac{1}{2} USD} \leq 0.29$$
where, “USD” represents a diagonal length of an effective screen surface of the panel, and “OAH” represents a vertical length from a center of the outer surface of the panel to a seal surface of the panel.

8. The cathode ray tube according to claim 1, wherein the predetermined inner surface curvature of the panel satisfies the following condition:
Rix≦Riy<Rid or
Riy≦Rix<Rid
where, “Rix” represents a radius of the inner surface curvature of the panel along the longer axis of the panel, “Riy” represents a radius of the inner surface curvature of the panel along the shorter axis of the panel, and “Rid” represents a radius of the inner surface curvature of the panel along the diagonal axis of the panel.

9. The cathode ray tube according to claim 1, wherein the cathode ray tube has a deflection angle of 120° or more.

10. A cathode ray tube comprising a panel having a predetermined curvature at an inner surface of the panel, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein:
the panel has a predetermined curvature at an outer surface of the panel such that the predetermined outer surface curvature satisfies a condition “5,000 mm≦Rx, Ry, Rd≦30,000 mm” and a condition that at least one of Rx, Ry, and Rd is different from the remaining ones of Rx, Ry, and Rd, where “Rx” represents a radius of the outer surface curvature of the panel along a longer axis of the panel, “Ry” represents a radius of the outer surface curvature of the panel along a shorter axis of the panel, and “Rd” represents a radius of the outer surface curvature of the panel along a diagonal axis of the panel.

11. The cathode ray tube according to claim 10, wherein the outer surface curvature radii of the panel along respective axes of the panel satisfy a condition “Rx≦Ry<Rd” or “Ry≦Rx<Rd”.

12. The cathode ray tube according to claim 10, wherein the panel has a ratio of transmissivity of a central panel portion to a transmissivity of each diagonal panel end portion ranging from 40% to 60%.

13. The cathode ray tube according to claim 10, wherein the shadow mask is made of an invar material.

14. The cathode ray tube according to claim 10, wherein the shadow mask is made of aluminum killed (AK) material.

15. The cathode ray tube according to claim 10, wherein the panel satisfies the following condition:
$$0.18 \leq \frac{OAH}{\frac{1}{2} USD} \leq 0.29$$
where, “USD” represents a diagonal length of an effective screen surface of the panel, and “OAH” represents a vertical length from a center of the outer surface of the panel to a seal surface of the panel.

16. The cathode ray tube according to claim 10, wherein the predetermined inner surface curvature of the panel satisfies the following condition:
Rix≦Riy<Rid or
Riy≦Rix<Rid
where, “Rix” represents a radius of the inner surface curvature of the panel along the longer axis of the panel, “Riy” represents a radius of the inner surface curvature of the panel along the shorter axis of the panel, and “Rid” represents a radius of the inner surface curvature of the panel along the diagonal axis of the panel.

17. The cathode ray tube according to claim 10, wherein the cathode ray tube has a deflection angle of 120° or more.

18. A cathode ray tube comprising a panel having a predetermined curvature at an inner surface of the panel, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein:
the panel has a predetermined curvature at an outer surface of the panel such that the predetermined outer surface curvature satisfies the following condition:
Rx≦Ry<Rd or
Ry≦Rx<Rd
where, “Rx” represents a radius of the outer surface curvature of the panel along a longer axis of the panel, “Ry” represents a radius of the outer surface curvature of the panel along a shorter axis of the panel, and “Rd” represents a radius of the outer surface curvature of the panel along a diagonal axis of the panel.

19. The cathode ray tube according to claim 18, wherein the outer surface curvature radii of the panel along respective axes of the panel satisfy the following condition:
$$0.5 \leq \frac{Rx + Ry}{2 \times Rd} \leq 0.9 .$$

20. The cathode ray tube according to claim 18, wherein the panel has a ratio of transmissivity of a central panel portion to a transmissivity of each diagonal panel end portion ranging from 40% to 60%.

21. The cathode ray tube according to claim 18, wherein the shadow mask is made of an invar material.

22. The cathode ray tube according to claim 18, wherein the shadow mask is made of aluminum killed (AK) material.

23. The cathode ray tube according to claim 18, wherein the panel satisfies the following condition:
$$0.18 \leq \frac{OAH}{\frac{1}{2} USD} \leq 0.29$$
where, “USD” represents a diagonal length of an effective screen surface of the panel, and “OAH” represents a vertical length from a center of the outer surface of the panel to a seal surface of the panel.

24. The cathode ray tube according to claim 18, wherein the predetermined inner surface curvature of the panel satisfies the following condition:
Rix≦Riy<Rid or
Riy≦Rix<Rid
where, “Rix” represents a radius of the inner surface curvature of the panel along the longer axis of the panel, “Riy” represents a radius of the inner surface curvature of the panel along the shorter axis of the panel, and “Rid” represents a radius of the inner surface curvature of the panel along the diagonal axis of the panel.

25. The cathode ray tube according to claim 18, wherein the cathode ray tube has a deflection angle of 120° or more.
